(19) United States
(12) Patent Application Publication
(10) Pub. No.: US 2009/0203917 A1
(43) Pub. Date: Aug. 13, 2009

(54) ORGANOMETALLIC COMPOUNDS, PROCESSES FOR THE PREPARATION THEREOF AND METHODS OF USE THEREOF

(76) Inventors: David M. Thompson, East Amherst, NY (US); Joan Geary, Lakeview, NY (US); Adrien R. Lavoie, St. Helens, OR (US); Juan E. Dominquez, Hillsboro, OR (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/352,202

(22) Filed: Jan. 12, 2009

Related U.S. Application Data
(60) Provisional application No. 61/023,125, filed on Jan. 24, 2008.

(51) Int. Cl. C07F 15/00

(52) U.S. Cl. 548/103; 556/21; 556/136; 556/7

(57) ABSTRACT

This invention relates to organometallic compounds having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different, a process for producing the organometallic compounds, and a method for producing a film or coating from the organometallic compounds. The organometallic compounds are useful in semiconductor applications as chemical vapor or atomic layer deposition precursors for film depositions.

### RELATED APPLICATIONS

This application claims priority from provisional U.S. Patent Application Ser. No. 61/023,125, filed Jan. 24, 2008, which is incorporated herein by reference. This application is related to U.S. patent application Ser. No. (21646-R1), filed on an even date herewith, U.S. patent application Ser. No. (21646-R3), filed on an even date herewith, U.S. patent application Ser. No. (21699-R1), filed on an even date herewith, U.S. patent application Ser. No. (21699-R2), filed on an even date herewith, U.S. patent application Ser. No. (21699-R3), filed on an even date herewith, U.S. patent application Ser. No. (21700-R1), filed on an even date herewith, U.S. patent application Ser. No. (21700-R2), filed on an even date herewith, U.S. patent application Ser. No. (21700-R3), filed on an even date herewith, U.S. Patent Application Ser. No. 61/023,131, filed Jan. 24, 2008, and U.S. Patent Application Ser. No. 61/023,136, filed Jan. 24, 2008, all of which are incorporated herein by reference.

### FIELD OF THE INVENTION

This invention relates to organometallic compounds, a process for producing organometallic compounds, and a method for producing a film or coating from organometallic precursor compounds.

### BACKGROUND OF THE INVENTION

The semiconductor industry is currently considering the use of thin films of various metals for a variety of applications. Many organometallic complexes have been evaluated as potential precursors for the formation of these thin films. A need exists in the industry for developing new compounds and for exploring their potential as precursors for film depositions. The industry movement from physical vapor deposition (PVD) to chemical vapor deposition (CVD) and atomic layer deposition (ALD) processes, due to the increased demand for higher uniformity and conformality in thin films, has lead to a demand for suitable precursors for future semiconductor materials.

Many organometallic complexes have been evaluated as potential precursors for the formation of these thin films. These include, for example, carbonyl complexes such as Ru₃(CO)₁₂, diene complexes such as Ru(η³-C₆H₈)(CO)₃, Ru(η³-C₆H₈)(η⁶-C₆H₆), beta-diketonates such as Ru(DPM)₃, Ru(OD)₃ and ruthenocenes such as RuCp₂, Ru(EtCp)₂.

Both the carbonyl and diene complexes tend to exhibit low thermal stabilities which complicates their processing. While the beta-diketonates are thermally stable at moderate temperatures, their low vapor pressures married with their solid state at room temperature make it difficult to achieve high growth rates during film deposition.

Ruthenocenes have received considerable attention as precursors for Ru thin film deposition. While ruthenocene is a solid, the functionalization of the two cyclopentadienyl ligands with ethyl substituents yields a liquid precursor that shares the chemical characteristics of the parent ruthenocene. Unfortunately, depositions with this precursor have generally exhibited long incubation times and poor nucleation densities.

The ability to deposit conformal metal layers in high aspect ratio features by the dissociation of organometallic precursors has gained interest in recent years due to the development of chemical vapor deposition (CVD) techniques. In such techniques, an organometallic precursor comprising a metal component and organic component is introduced into a processing chamber and dissociates to deposit the metal component on a substrate while the organic portion of the precursor is exhausted from the chamber.

There are few commercially available organometallic precursors for the deposition of metal layers, such as ruthenium precursors by CVD techniques. The precursors that are available produce layers which may have unacceptable levels of contaminants such as carbon and oxygen, and may have less than desirable diffusion resistance, low thermal stability, and undesirable layer characteristics. Further, in some cases, the available precursors used to deposit metal layers produce layers with high resistivity, and in some cases, produce layers that are insulative.

Atomic layer deposition (ALD) is considered a superior technology for depositing thin films. However, the challenge for ALD technology is availability of suitable precursors. ALD deposition process involves a sequence of steps. The steps include 1) adsorption of precursors on the surface of substrate; 2) purging off excess precursor molecules in gas phase; 3) introducing reactants to react with precursor on the substrate surface; and 4) purging off excess reactant.

For ALD processes, the precursor should meet stringent requirements. First, the ALD precursors should be able to form a monolayer on the substrate surface either through physisorption or chemisorption under the deposition conditions. Second, the adsorbed precursor should be stable enough to prevent premature decomposition on the surface to result in high impurity levels. Third, the adsorbed molecule should be reactive enough to interact with reactants to leave a pure phase of the desirable material on the surface at relatively low temperature.

As with CVD, there are few commercially available organometallic precursors for the deposition of metal layers, such as ruthenium precursors by ALD techniques. ALD precursors that are available may have one or more of following disadvantages: 1) low vapor pressure, 2) wrong phase of the deposited material, and 3) high carbon incorporation in the film.

In developing methods for forming thin films by chemical vapor deposition or atomic layer deposition methods, a need continues to exist for precursors that preferably are liquid at room temperature, have adequate vapor pressure, have appropriate thermal stability (i.e., for chemical vapor deposition will decompose on the heated substrate but not during delivery, and for atomic layer deposition will not decompose thermally but will react when exposed to co-reactant), can form uniform films, and will leave behind very little, if any, undesired impurities (e.g., halides, carbon, etc.). Therefore, a need continues to exist for developing new compounds and for exploring their potential as chemical vapor or atomic layer deposition precursors for film depositions. It would therefore be desirable in the art to provide a precursor that possesses some, or preferably all, of the above characteristics.

### SUMMARY OF THE INVENTION

This invention relates in part to compounds having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

This invention also relates in part to organometallic precursors represented by the formula above.

This invention further relates in part to a process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises reacting a metal halide and a first salt in the presence of a first solvent and under reaction conditions sufficient to produce an intermediate reaction material, and reacting said intermediate reaction material with a second salt in the presence of a second solvent and under reaction conditions sufficient to produce said organometallic compound.

This invention yet further relates in part to a process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises reacting a metal halide with an excess stoichiometric amount of a salt in the presence of a solvent and under reaction conditions sufficient to produce said organometallic compound.

This invention also relates in part to a process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises dissolving or suspending a substituted or unsubstituted organometallic compound intermediate having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same, in a solvent to form a solution or suspension, and adding a substituted or unsubstituted 6 electron donor anionic ligand source material to said solution or suspension under conditions sufficient to produce said organometallic compound.

This invention further relates in part to a method for producing a film, coating or powder by decomposing an organometallic precursor compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; thereby producing said film, coating or powder.

This invention yet further relates in part to a method for processing a substrate in a processing chamber, said method comprising (i) introducing an organometallic precursor compound into said processing chamber, (ii) heating said substrate to a temperature of about 100° C. to about 600° C., and (iii) reacting said organometallic precursor compound in the presence of a processing gas to deposit a metal-containing layer on said substrate; wherein said organometallic precursor compound has the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

This invention also relates in part to a method for forming a metal-containing material on a substrate from an organometallic precursor compound, said method comprising vaporizing said organometallic precursor compound to form a vapor, and contacting the vapor with the substrate to form said metal material thereon; wherein said organometallic precursor compound has the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

This invention further relates in part to a method of fabricating a microelectronic device structure, said method comprising vaporizing an organometallic precursor compound to form a vapor, and contacting said vapor with a substrate to deposit a metal-containing film on the substrate, and thereafter incorporating the metal-containing film into a semiconductor integration scheme; wherein said organometallic precursor compound has the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

This invention yet further relates in part to mixtures comprising (i) a first organometallic precursor compound represented by the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (a) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (b) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (c) when L₁ is a substituted or unsubstituted pentadienyl group, then L₂ is other than a substituted or unsubstituted pentadienyl group; and (ii) one or more different organometallic precursor compounds (e.g., a hafnium-containing, tantalum-containing or molybdenum-containing organometallic precursor compound).

This invention relates in particular to depositions involving 6-electron donor anionic ligand-based ruthenium precursors. These precursors can provide advantages over the other known precursors, especially when utilized in tandem with other ‘next-generation’ materials (e.g., hafnium, tantalum and molybdenum). These ruthenium-containing materials can be used for a variety of purposes such as dielectrics, adhesion layers, diffusion barriers, electrical barriers, and electrodes, and in many cases show improved properties (thermal stability, desired morphology, less diffusion, lower leakage, less charge trapping, and the like) than the non-ruthenium containing films.

The invention has several advantages. For example, the method of the invention is useful in generating organometallic precursor compounds that have varied chemical structures and physical properties. Films generated from the organometallic precursor compounds can be deposited with a short incubation time, and the films deposited from the organometallic precursor compounds exhibit good smoothness. These 6-electron donor anionic ligand-containing ruthenium precursors may be deposited by atomic layer deposition employing a hydrogen reduction pathway in a self-limiting manner, thereby enabling use of ruthenium as a barrier/adhesion layer in conjunction with tantalum nitride in BEOL (back end of line) liner applications. Such 6-electron donor anionic ligand-containing ruthenium precursors deposited in a self-limiting manner by atomic layer deposition may enable conformal film growth over high aspect ratio trench architectures in a reducing environment.

A preferred embodiment of this invention is that the organometallic precursor compounds may be liquid at room temperature. In some situations, liquids may be preferred over solids from an ease of semiconductor process integration perspective. The 6-electron donor anionic ligand-containing ruthenium compounds are preferably hydrogen reducible and deposit in a self-limiting manner.

For CVD and ALD applications, the organometallic precursors of this invention can exhibit an ideal combination of thermal stability, vapor pressure, and reactivity with the intended substrates for semiconductor applications. The organometallic precursors of this invention can desirably exhibit liquid state at delivery temperature, and/or tailored ligand spheres that can lead to better reactivity with semiconductor substrates.

### DETAILED DESCRIPTION OF THE INVENTION

As indicated above, this invention relates to compounds represented by the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

Other compounds within the scope of this invention can be represented by the formula L₁ML₂ wherein M is a metal or metalloid, L₁ is selected from a substituted or unsubstituted cyclopentadienyl group or a substituted or unsubstituted cyclopentadienyl-like group, and L₂ is selected from a substituted or unsubstituted cycloheptadienyl group, a substituted or unsubstituted cycloheptadienyl-like group, a substituted or unsubstituted boratabenzene group, a substituted or unsubstituted boratabenzene-like group, a substituted or unsubstituted imidazolyl group or a substituted or unsubstituted imidazolyl-like group.

Illustrative substituted or unsubstituted cyclopentadienyl-like group is selected from cyclohexadienyl, cycloheptadienyl, cyclooctadienyl, heterocyclic group and aromatic group, the substituted or unsubstituted cycloheptadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl.

Other compounds within the scope of this invention can be represented by the formula L₁ML₂ wherein M is a metal or metalloid, L₁ is selected from a substituted or unsubstituted cycloheptadienyl group or a substituted or unsubstituted cycloheptadienyl-like group, and L₂ is selected from a substituted or unsubstituted pentadienyl group, a substituted or unsubstituted pentadienyl-like group, a substituted or unsubstituted cyclopentadienyl group, a substituted or unsubstituted cyclopentadienyl-like group, a substituted or unsubstituted boratabenzene group, a substituted or unsubstituted boratabenzene-like group, a substituted or unsubstituted imidazolyl group or a substituted or unsubstituted imidazolyl-like group.

Illustrative substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl.

Other compounds within the scope of this invention can be represented by the formula L₁ML₂ wherein M is a metal or metalloid, L₁ is selected from a substituted or unsubstituted pentadienyl group or a substituted or unsubstituted pentadienyl-like group, and L₂ is selected from a substituted or unsubstituted cycloheptadienyl group, a substituted or unsubstituted cycloheptadienyl-like group, a substituted or unsubstituted boratabenzene group, a substituted or unsubstituted boratabenzene-like group, a substituted or unsubstituted imidazolyl group or a substituted or unsubstituted imidazolyl-like group.

Illustrative substituted or unsubstituted pentadienyl-like group is selected from linear olefins, hexadienyl, heptadienyl and octadienyl, the substituted or unsubstituted cycloheptadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl.

Other compounds within the scope of this invention can be represented by the formula L₁ML₂ wherein M is a metal or metalloid, L₁ is selected from a substituted or unsubstituted pyrrolyl group or a substituted or unsubstituted pyrrolyl-like group, and L₂ is selected from a substituted or unsubstituted boratabenzene group, a substituted or unsubstituted boratabenzene-like group, a substituted or unsubstituted imidazolyl group or a substituted or unsubstituted imidazolyl-like group.

Illustrative substituted or unsubstituted pyrrolyl-like group is selected from pyrrolinyl, pyrazolyl, thiazolyl, oxazolyl, carbazolyl, triazolyl, indolyl and purinyl, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl.

Other compounds within the scope of this invention can be represented by the formula L₁ML₂ wherein M is a metal or metalloid, L₁ is selected from a substituted or unsubstituted boratabenzene group or a substituted or unsubstituted boratabenzene-like group, and L₂ is selected from a substituted or unsubstituted pentadienyl group, a substituted or unsubstituted pentadienyl-like group, a substituted or unsubstituted cycloheptadienyl group, a substituted or unsubstituted cycloheptadienyl-like group, a substituted or unsubstituted cyclopentadienyl group, a substituted or unsubstituted cyclopentadienyl-like group, a substituted or unsubstituted pyrrolyl group, a substituted or unsubstituted pyrrolyl-like group, a substituted or unsubstituted imidazolyl group or a substituted or unsubstituted imidazolyl-like group.

Illustrative substituted or unsubstituted boratabenzene-like group is selected from methylboratabenzene, ethylboratabenzene and 1-methyl-3-ethylboratabenzene, the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted pyrrolyl-like group is selected from pyrrolinyl, pyrazolyl, thiazolyl, oxazolyl, carbazolyl, triazolyl, indolyl and purinyl, and the substituted or unsubstituted imidazolyl-like group is selected from pyrrolinyl, pyrazolyl, thiazolyl, oxazolyl, carbazolyl, triazolyl, indolyl and purinyl.

Other compounds within the scope of this invention can be represented by the formula L₁ML₂ wherein M is a metal or metalloid, L₁ is selected from a substituted or unsubstituted imidazolyl group or a substituted or unsubstituted imidazolyl-like group, and L₂ is selected from a substituted or unsubstituted pentadienyl group, a substituted or unsubstituted pentadienyl-like group, a substituted or unsubstituted cycloheptadienyl group, a substituted or unsubstituted cycloheptadienyl-like group, a substituted or unsubstituted cyclopentadienyl group, a substituted or unsubstituted cyclopentadienyl-like group, a substituted or unsubstituted pyrrolyl group, a substituted or unsubstituted pyrrolyl-like group, a substituted or unsubstituted boratabenzene group, a substituted or unsubstituted boratabenzene-like group, a substituted or unsubstituted imidazolyl group which can be the same or different as L₁ or a substituted or unsubstituted imidazolyl-like group which can be the same or different as L₁.

Illustrative substituted or unsubstituted imidazolyl-like groups are the same or different and are selected from pyrrolinyl, pyrazolyl, thiazolyl, oxazolyl, carbazolyl, triazolyl, indolyl and purinyl, the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted pyrrolyl-like group is selected from pyrrolinyl, pyrazolyl, thiazolyl, oxazolyl, carbazolyl, triazolyl, indolyl and purinyl, and the substituted or unsubstituted boratabenzene-like group is selected from methylboratabenzene, ethylboratabenzene and 1-methyl-3-ethylboratabenzene.

This invention in part provides organometallic precursor compounds and a method of processing a substrate to form a metal-based material layer, e.g., ruthenium layer, on the substrate by CVD or ALD of the organometallic precursor compound. The metal-based material layer is deposited on a heated substrate by thermal or plasma enhanced dissociation of the organometallic precursor compound having the formula above in the presence of a processing gas. The processing gas may be an inert gas, such as helium and argon, and combinations thereof. The composition of the processing gas is selected to deposit metal-based material layers, e.g., ruthenium layers, as desired.

For the organometallic precursor compounds of this invention represented by the formula above, M, represents the metal to be deposited. Examples of metals which can be deposited according to this invention are Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, Si, Ge, a Lanthanide series element or an Actinide series element.

Illustrative substituted and unsubstituted anionic ligands (L₁) and (L₂) useful in this invention include, for example, 6 electron anionic donor ligands such as cyclopentadienyl (Cp), cycloheptadienyl, pentadienyl, pyrrolyl, boratabenzene, pyrazolyl, imidazolyl, and the like. Cp is a cyclopentadienyl ring having the general formula (C₅H₅⁻) which forms a ligand with the metal, M. The cyclopentadienyl ring may be substituted, thereby having the formula (Cp(R′). The precursor contains two 6 electron anionic donor ligand groups, e.g., cyclopentadienyl groups.

Other illustrative substituted and unsubstituted 6 electron anionic donor ligands include cyclodienyl complexes, e.g., cyclohexadienyl, cycloheptadienyl, cyclooctadienyl rings, heterocyclic rings, aromatic rings, such as substituted cyclopentadienyl ring like ethylcyclopentadienyl, and others, as known in the art.

Permissible substituents of the substituted 6 electron anionic donor ligands used herein include halogen atoms, acyl groups having from 1 to about 12 carbon atoms, alkoxy groups having from 1 to about 12 carbon atoms, alkoxycarbonyl groups having from 1 to about 12 carbon atoms, alkyl groups having from 1 to about 12 carbon atoms, amine groups having from 1 to about 12 carbon atoms or silyl groups having from 0 to about 12 carbon atoms.

Illustrative halogen atoms include, for example, fluorine, chlorine, bromine and iodine. Preferred halogen atoms include chlorine and fluorine.

Illustrative acyl groups include, for example, formyl, acetyl, propionyl, butyryl, isobutyryl, valeryl, 1-methylpropylcarbonyl, isovaleryl, pentylcarbonyl, 1-methylbutylcarbonyl, 2-methylbutylcarbonyl, 3-methylbutylcarbonyl, 1-ethylpropylcarbonyl, 2-ethylpropylcarbonyl, and the like. Preferred acyl groups include formyl, acetyl and propionyl.

Illustrative alkoxy groups include, for example, methoxy, ethoxy, n-propoxy, isopropoxy, n-butoxy, isobutoxy, sec-butoxy, tert-butoxy, pentyloxy, 1-methylbutyloxy, 2-methylbutyloxy, 3-methylbutyloxy, 1,2-dimethylpropyloxy, hexyloxy, 1-methylpentyloxy, 1-ethylpropyloxy, 2-methylpentyloxy, 3-methylpentyloxy, 4-methylpentyloxy, 1,2-dimethylbutyloxy, 1,3-dimethylbutyloxy, 2,3-dimethylbutyloxy, 1,1-dimethylbutyloxy, 2,2-dimethylbutyloxy, 3,3-dimethylbutyloxy, and the like. Preferred alkoxy groups include methoxy, ethoxy and propoxy.

Illustrative alkoxycarbonyl groups include, for example, methoxycarbonyl, ethoxycarbonyl, propoxycarbonyl, isopropoxycarbonyl, cyclopropoxycarbonyl, butoxycarbonyl, isobutoxycarbonyl, sec-butoxycarbonyl, tert-butoxycarbonyl, and the like. Preferred alkoxycarbonyl groups include methoxycarbonyl, ethoxycarbonyl, propoxycarbonyl, isopropoxycarbonyl and cyclopropoxycarbonyl.

Illustrative alkyl groups include, for example, methyl, ethyl, n-propyl, isopropyl, n-butyl, isobutyl, sec-butyl, tert-butyl, pentyl, isopentyl, neopentyl, tert-pentyl, 1-methylbutyl, 2-methylbutyl, 1,2-dimethylpropyl, hexyl, isohexyl, 1-methylpentyl, 2-methylpentyl, 3-methylpentyl, 1,1-dimethylbutyl, 2,2-dimethylbutyl, 1,3-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, cyclopropyl, cyclobutyl, cyclopentyl, cyclohexyl, cyclopropylmethyl, cyclopropylethyl, cyclobutylmethyl, and the like. Preferred alkyl groups include methyl, ethyl, n-propyl, isopropyl and cyclopropyl.

Illustrative amine groups include, for example, methylamine, dimethylamine, ethylamine, diethylamine, propylamine, dipropylamine, isopropylamine, diisopropylamine, butylamine, dibutylamine, tert-butylamine, di(tert-butyl)amine, ethylmethylamine, butylmethylamine, cyclohexylamine, dicyclohexylamine, and the like. Preferred amine groups include dimethylamine, diethylamine and diisopropylamine.

Illustrative silyl groups include, for example, silyl, trimethylsilyl, triethylsilyl, tris(trimethylsilyl)methyl, trisilylmethyl, methylsilyl and the like. Preferred silyl groups include silyl, trimethylsilyl and triethylsilyl.

Illustrative substituted chleated diene ligands include substituted cyclo-olefins, e.g., cyclopentadiene, the various isomers of cyclohexadiene, cycloheptadiene, cyclooctadiene rings, heterocyclic rings, aromatic rings, and others, as known in the art.

Permissible substituents of the substituted chelated diene ligands include halogen atoms, acyl groups having from 1 to about 12 carbon atoms, alkoxy groups having from 1 to about 12 carbon atoms, alkoxycarbonyl groups having from 1 to about 12 carbon atoms, alkyl groups having from 1 to about 12 carbon atoms, amine groups having from 1 to about 12 carbon atoms or silyl groups having from 0 to about 12 carbon atoms.

In an embodiment, this invention relates in part to ruthenium compounds represented by the following formulae:

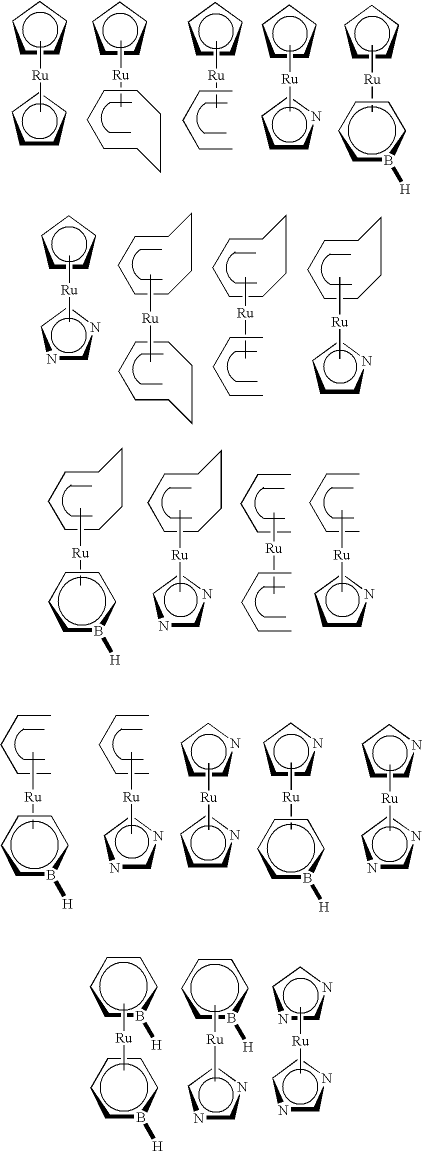

Illustrative compounds of this invention include, for example, the following (cyclopentadienyl)(cycloheptadienyl)ruthenium, (cyclopentadienyl)(methylboratabenzene)ruthenium, (cyclopentadienyl)(imidazolyl)ruthenium, (pentadienyl)(cycloheptadienyl)ruthenium, (pentadienyl)(boratabenzene)ruthenium, (pentadienyl)(imidazolyl)ruthenium, (cycloheptadienyl)(methylboratabenzene)ruthenium, (cycloheptadienyl)(imidazolyl)ruthenium, (pyrrolyl)(methylboratabenzene)ruthenium, (pyrrolyl)(imidazolyl)ruthenium, (methylboratabenzene)(imidazolyl)ruthenium, bis(imidazolyl)ruthenium, (ethylcyclopentadienyl)(cycloheptadienyl)ruthenium, (methylboratabenzene)(cycloheptadienyl)ruthenium, bis(ethylboratabenzene)ruthenium, and the like.

Other illustrative compounds of this invention include, for example, the following (cyclopentadienyl)(cycloheptadienyl)ruthenium, (methylcyclopentadienyl)(cycloheptadienyl)ruthenium, (ethylcyclopentadienyl)(cycloheptadienyl)ruthenium, (methylcyclopentadienyl)(methylboratabenzene)ruthenium, (ethylcyclopentadienyl)(methylboratabenzene)ruthenium, (cyclopentadienyl)(methylboratabenzene)ruthenium, (methylcyclopentadienyl)(methylboratabenzene)ruthenium, (cyclopentadienyl)(imidazolyl)ruthenium, (methylcyclopentadienyl)(imidazolyl)ruthenium, (ethylcyclopentadienyl)(imidazolyl)ruthenium, (isopropylcyclopentadienyl)(cycloheptadienyl)ruthenium, (tert-butylcyclopentadienyl)(cycloheptadienyl)ruthenium, (isopropylcyclopentadienyl)(methylboratabenzene)ruthenium, (tert-butylcyclopentadienyl)(methylboratabenzene)ruthenium, (isopropylcyclopentadienyl)(imidazolyl)ruthenium, (tert-butylcyclopentadienyl)(imidazolyl)ruthenium, (pentadienyl)(cycloheptadienyl)ruthenium, (2,4-dimethylpentadienyl)(cycloheptadienyl)ruthenium, (pentadienyl)(methylboratabenzene)ruthenium, (pentadienyl)(imidazolyl)ruthenium, (cyclohexadienyl)(cycloheptadienyl)ruthenium, (cyclopentadienyl)(cyclohexadienyl)ruthenium, (cyclohexadienyl)(methylboratabenzene)ruthenium, (cyclohexadienyl)(imidazolyl)ruthenium, (cycloheptadienyl)(methylboratabenzene)ruthenium, (cycloheptadienyl)(imidazolyl)ruthenium, (methylboratabenzene)(pyrrolyl)ruthenium, (imidazolyl)(pyrrolyl)ruthenium, (methylboratabenzene)(imidazolyl)ruthenium, bis(imidazolyl)ruthenium, (ethylcyclopentadienyl)(cycloheptadienyl)ruthenium, (methylboratabenzene)(cycloheptadienyl)ruthenium, bis(ethylboratabenzene)ruthenium, and the like.

As indicated above, this invention also relates to mixtures comprising (i) a first organometallic precursor compound represented by the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (a) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (b) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (c) when L₁ is a substituted or unsubstituted pentadienyl group, then L₂ is other than a substituted or unsubstituted pentadienyl group; and (ii) one or more different organometallic precursor compounds (e.g., a hafnium-containing, tantalum-containing or molybdenum-containing organometallic precursor compound).

With respect to the claimed compounds of this invention, the following limitations apply: (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

It is believed that the presence of the 6 electron donor anionic ligand groups enhance preferred physical properties. It is believed that appropriate choice of these substituent groups can increase organometallic precursor volatility, decrease or increase the temperature required to dissociate the precursor, and lower the boiling point of the organometallic precursor. An increased volatility of the organometallic precursor compounds ensures a sufficiently high concentration of precursor entrained in vaporized fluid flow to the processing chamber for effective deposition of a layer. The improved volatility will also allow the use of vaporization of the organometallic precursor by sublimation and delivery to a processing chamber without risk of premature dissociation. Additionally, the presence of the 6 electron anionic donor substituent groups may also provide sufficient solubility of the organometallic precursor for use in liquid delivery systems.

It is believed that appropriate selection of the 6-electron anionic donors for the organometallic precursors described herein have functional groups which allow the formation of heat decomposable organometallic compounds that are thermally stable at temperatures below about 150° C. and that are capable of thermally dissociating at a temperature above about 150° C. The organometallic precursors are also capable of dissociation in a plasma generated by supplying a power density at about 0.6 Watts/cm² or greater, or at about 200 Watts or greater for a 200 mm substrate, to a processing chamber.

The organometallic precursors described herein may deposit metal layers depending on the processing gas composition and the plasma gas composition for the deposition process. A metal layer is deposited in the presence of inert processing gases such as argon, a reactant processing gas, such as hydrogen, and combinations thereof.

It is believed that the use of a reactant processing gas, such as hydrogen, facilitates reaction with the 6 electron anionic donor groups to form volatile species that may be removed under low pressure, thereby removing the substituents from the precursor and depositing a metal layer on the substrate. The metal layer is preferably deposited in the presence of argon.

An exemplary processing regime for depositing a layer from the above described precursor is as follows. A precursor having the composition described herein, such as (cyclopentadienyl)(cycloheptadienyl)ruthenium, and a processing gas are introduced into a processing chamber. The precursor is introduced at a flow rate between about 5 and about 500 sccm and the processing gas is introduced into the chamber at a flow rate of between about 5 and about 500 sccm. In one embodiment of the deposition process, the precursor and processing gas are introduced at a molar ratio of about 1:1. The processing chamber is maintained at a pressure between about 100 milliTorr and about 20 Torr. The processing chamber is preferably maintained at a pressure between about 100 milliTorr and about 250 milliTorr. Flow rates and pressure conditions may vary for different makes, sizes, and models of the processing chambers used.

Thermal dissociation of the precursor involves heating the substrate to a temperature sufficiently high to cause the hydrocarbon portion of the volatile metal compound adjacent the substrate to dissociate to volatile hydrocarbons which desorb from the substrate while leaving the metal on the substrate. The exact temperature will depend upon the identity and chemical, thermal, and stability characteristics of the organometallic precursor and processing gases used under the deposition conditions. However, a temperature from about room temperature to about 400° C. is contemplated for the thermal dissociation of the precursor described herein.

The thermal dissociation is preferably performed by heating the substrate to a temperature between about 100° C. and about 600° C. In one embodiment of the thermal dissociation process, the substrate temperature is maintained between about 250° C. and about 450° C. to ensure a complete reaction between the precursor and the reacting gas on the substrate surface. In another embodiment, the substrate is maintained at a temperature below about 400° C. during the thermal dissociation process.

For plasma-enhanced CVD processes, power to generate a plasma is then either capacitively or inductively coupled into the chamber to enhance dissociation of the precursor and increase reaction with any reactant gases present to deposit a layer on the substrate. A power density between about 0.6 Watts/cm² and about 3.2 Watts/cm², or between about 200 and about 1000 Watts, with about 750 Watts most preferably used for a 200 mm substrate, is supplied to the chamber to generate the plasma.

After dissociation of the precursor and deposition of the material on the substrate, the deposited material may be exposed to a plasma treatment. The plasma comprises a reactant processing gas, such as hydrogen, an inert gas, such as argon, and combinations thereof. In the plasma-treatment process, power to generate a plasma is either capacitively or inductively coupled into the chamber to excite the processing gas into a plasma state to produce plasma specie, such as ions, which may react with the deposited material. The plasma is generated by supplying a power density between about 0.6 Watts/cm² and about 3.2 Watts/cm², or between about 200 and about 1000 Watts for a 200 mm substrate, to the processing chamber.

In one embodiment the plasma treatment comprises introducing a gas at a rate between about 5 sccm and about 300 sccm into a processing chamber and generating a plasma by providing power density between about 0.6 Watts/cm² and about 3.2 Watts/cm², or a power at between about 200 Watts and about 1000 Watts for a 200 mm substrate, maintaining the chamber pressure between about 50 milliTorr and about 20 Torr, and maintaining the substrate at a temperature of between about 100° C. and about 600° C. during the plasma process.

It is believed that the plasma treatment lowers the layer's resistivity, removes contaminants, such as carbon or excess hydrogen, and densifies the layer to enhance barrier and liner properties. It is believed that species from reactant gases, such as hydrogen species in the plasma react with the carbon impurities to produce volatile hydrocarbons that can easily desorb from the substrate surface and can be purged from the processing zone and processing chamber. Plasma species from inert gases, such as argon, further bombard the layer to remove resistive constituents to lower the layers resistivity and improve electrical conductivity.

Plasma treatments are preferably not performed for metal layers, since the plasma treatment may remove the desired carbon content of the layer. If a plasma treatment for a metal layer is performed, the plasma gases preferably comprise inert gases, such as argon and helium, to remove carbon.

It is believed that depositing layers from the above identified precursors and exposing the layers to a post deposition plasma process will produce a layer with improved material properties. The deposition and/or treatment of the materials described herein are believed to have improved diffusion resistance, improved interlayer adhesion, improved thermal stability, and improved interlayer bonding.

In an embodiment of this invention, a method for metallization of a feature on a substrate is provided that comprises depositing a dielectric layer on the substrate, etching a pattern into the substrate, depositing a metal layer on the dielectric layer, and depositing a conductive metal layer on the metal layer. The substrate may be optionally exposed to reactive pre-clean comprising a plasma of hydrogen and argon to remove oxide formations on the substrate prior to deposition of the metal layer. The conductive metal is preferably copper and may be deposited by physical vapor deposition, chemical vapor deposition, or electrochemical deposition. The metal layer is deposited by the thermal or plasma enhanced dissociation of an organometallic precursor of this invention in the presence of a processing gas, preferably at a pressure less than about 20 Torr. Once deposited, the metal layer can be exposed to a plasma prior to subsequent layer deposition.

Current copper integration schemes involve a diffusion barrier with a copper wetting layer on top followed by a copper seed layer. A layer of metal gradually becoming metal rich in accordance with this invention would replace multiple steps in the current integration schemes. The metal layer is an excellent barrier to copper diffusion due to its amorphous character. The metalrich layer functions as a wetting layer and may allow for direct plating onto the metal. This single layer could be deposited in one step by manipulating the deposition parameters during the deposition. A post deposition treatment may also be employed to increase the ratio of metal in the film. Removal of one or more steps in semiconductor manufacture will result in substantial savings to the semiconductor manufacturer.

Metal films are deposited at temperatures lower than 400° C. and form no corrosive byproducts. The metal films are amorphous and are superior barriers to copper diffusion. By tuning the deposition parameters and post deposition treatment, the metal barrier can have a metal rich film deposited on top of it. This metal rich film acts as a wetting layer for copper and may allow for direct copper plating on top of the metal layer. In an embodiment, the deposition parameters may be tuned to provide a layer in which the composition varies across the thickness of the layer. For example, the layer may be metal rich at the silicon portion surface of the microchip, e.g., good barrier properties, and metal rich at the copper layer surface, e.g., good adhesive properties.

As also indicated above, this invention relates in part to a process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises reacting a metal halide and a first salt in the presence of a first solvent and under reaction conditions sufficient to produce an intermediate reaction material, and reacting said intermediate reaction material with a second salt in the presence of a second solvent and under reaction conditions sufficient to produce said organometallic compound. The organometallic compound yield resulting from the process of this invention can be 40% or greater, preferably 35% or greater, and more preferably 30% or greater.

The process is particularly well-suited for large scale production since it can be conducted using the same equipment, some of the same reagents and process parameters that can easily be adapted to manufacture a wide range of products. The process provides for the synthesis of organometallic precursor compounds using a process where all manipulations can be carried out in a single vessel, and which route to the organometallic precursor compounds does not require the isolation of an intermediate complex.

The metal halide compound starting material may be selected from a wide variety of compounds known in the art. The invention herein most prefers metals selected from Ti, Zr, Hf. V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, Si, Ge, a Lanthanide series element or an Actinide series element. Illustrative metal halide compounds include, for example, Ru(PPh₃)₃Cl₂, Ru(PPh₃)₄Cl₂, [Ru(C₆H₆)Cl₂]₂, Ru(NCCH₃)₄Cl₂, [Ru(CO)₃Cl₂]₂, Fe(PPh₃)₃Cl₂, Os(PPh₃)₃Cl₂, and the like.

The concentration of the metal source compound starting material can vary over a wide range, and need only be that minimum amount necessary to react with the first salt to produce the intermediate reaction material and to provide the given metal concentration desired to be employed and which will furnish the basis for at least the amount of metal necessary for the organometallic compounds of this invention. In general, depending on the size of the reaction mixture, metal source compound starting material concentrations in the range of from about 1 millimole or less to about 10,000 millimoles or greater, should be sufficient for most processes.

The first salt starting material may be selected from a wide variety of compounds known in the art. Illustrative first salts include sodium cyclopentadienide, potassium cyclopentadienide, lithium cyclopentadienide, lithium 2,5-dimethylpyrrolide, trimethylsilyl methylboratabenzene, and the like. The first salt starting material is preferably sodium cyclopentadienide and the like.

The concentration of the first salt starting material can vary over a wide range, and need only be that minimum amount necessary to react with the metal source compound starting material to produce an intermediate reaction material. In general, depending on the size of the first reaction mixture, salt starting material concentrations in the range of from about 1 millimole or less to about 10,000 millimoles or greater, should be sufficient for most processes.

The first solvent employed in the method of this invention may be any saturated and unsaturated hydrocarbons, aromatic hydrocarbons, aromatic heterocycles, alkyl halides, silylated hydrocarbons, ethers, polyethers, thioethers, esters, thioesters, lactones, amides, amines, polyamines, silicone oils, other aprotic solvents, or mixtures of one or more of the above; more preferably, diethylether, pentanes, or dimethoxyethanes; and most preferably toluene or dimethoxyethane (DME) or mixtures thereof. Any suitable solvent which does not unduly adversely interfere with the intended reaction can be employed. Mixtures of one or more different solvents may be employed if desired. The amount of solvent employed is not critical to the subject invention and need only be that amount sufficient to solubilize the reaction components in the reaction mixture. In general, the amount of solvent may range from about 5 percent by weight up to about 99 percent by weight or more based on the total weight of the reaction mixture starting materials.

Reaction conditions for the reaction of the first salt compound with the metal source compound to produce the intermediate reaction material, such as temperature, pressure and contact time, may also vary greatly and any suitable combination of such conditions may be employed herein. The reaction temperature may be the reflux temperature of any of the aforementioned solvents, and more preferably between about −80° C. to about 210° C., and most preferably between about 20° C. to about 120° C. Normally the reaction is carried out under ambient pressure and the contact time may vary from a matter of seconds or minutes to a few hours or greater. The reactants can be added to the reaction mixture or combined in any order. The stir time employed can range from about 0.1 to about 400 hours, preferably from about 1 to 75 hours, and more preferably from about 4 to 16 hours, for all steps.

The intermediate reaction material may be selected from a wide variety of materials known in the art. Illustrative intermediate reaction materials include (EtCp)Ru(PPh3)₂Cl, (C₄H₄N)Ru(PPh₃)₂Cl, [(C₄H₄N)Ru(NCCH₃)₃]Cl, and the like. The intermediate reaction material is preferably (EtCp)Ru(PPh3)₂Cl, (C₄H₄N)Ru(PPh₃)₂Cl, or other L₁Ru(PPh₃)₂Cl species. The process of this invention does not require isolation of the intermediate reaction material.

The concentration of the intermediate reaction material can vary over a wide range, and need only be that minimum amount necessary to react with the base material to produce the organometallic compounds of this invention. In general, depending on the size of the second reaction mixture, intermediate reaction material concentrations in the range of from about 1 millimole or less to about 10,000 millimoles or greater, should be sufficient for most processes.

The second salt starting material may be selected from a wide variety of compounds known in the art. Illustrative second salts include lithium 2,5-dimethylpyrrolylide, lithium methylboratabenzene, sodium imidazolide, and the like. The second salt starting material is preferably 2,5-dimethylpyrrolylide and the like.

The concentration of the second salt starting material can vary over a wide range, and need only be that minimum amount necessary to react with the metal source compound starting material to produce an intermediate reaction material. In general, depending on the size of the first reaction mixture, salt starting material concentrations in the range of from about 1 millimole or less to about 10,000 millimoles or greater, should be sufficient for most processes.

The second solvent employed in the method of this invention may be any saturated and unsaturated hydrocarbons, aromatic hydrocarbons, aromatic heterocycles, alkyl halides, silylated hydrocarbons, ethers, polyethers, thioethers, esters, thioesters, lactones, amides, amines, polyamines, silicone oils, other aprotic solvents, or mixtures of one or more of the above; more preferably, diethylether, pentanes, or dimethoxyethanes; and most preferably toluene, hexane or mixtures thereof. Any suitable solvent which does not unduly adversely interfere with the intended reaction can be employed. Mixtures of one or more different solvents may be employed if desired. The amount of solvent employed is not critical to the subject invention and need only be that amount sufficient to solubilize the reaction components in the reaction mixture. In general, the amount of solvent may range from about 5 percent by weight up to about 99 percent by weight or more based on the total weight of the reaction mixture starting materials.

Reaction conditions for the reaction of the intermediate reaction material with the second salt material to produce the organometallic precursors of this invention, such as temperature, pressure and contact time, may also vary greatly and any suitable combination of such conditions may be employed herein. The reaction temperature may be the reflux temperature of any of the aforementioned solvents, and more preferably between about −80° C. to about 210° C., and most preferably between about 20° C. to about 120° C. Normally the reaction is carried out under ambient pressure and the contact time may vary from a matter of seconds or minutes to a few hours or greater. The reactants can be added to the reaction mixture or combined in any order. The stir time employed can range from about 0.1 to about 400 hours, preferably from about 1 to 75 hours, and more preferably from about 4 to 16 hours, for all steps.

Isolation of the complex may be achieved by filtering to remove solids, reduced pressure to remove solvent, and distillation (or sublimation) to afford the final pure compound. Chromatography may also be employed as a final purification method.

One example of the above process is shown below:

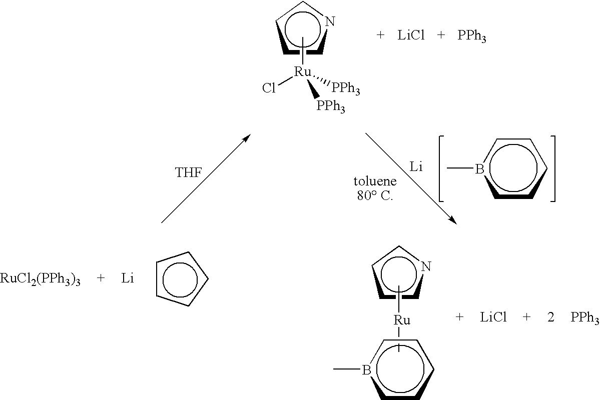

This invention also relates to another process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises reacting a metal halide with an excess stoichiometric amount of a salt in the presence of a solvent and under reaction conditions sufficient to produce said organometallic compound. The organometallic compound yield resulting from the process of this invention can be 40% or greater, preferably 35% or greater, and more preferably 30% or greater.

The process is particularly well-suited for large scale production since it can be conducted using the same equipment, some of the same reagents and process parameters that can easily be adapted to manufacture a wide range of products. The process provides for the synthesis of organometallic precursor compounds using a process where all manipulations can be carried out in a single vessel, and which route to the organometallic precursor compounds does not require the isolation of an intermediate complex.

The metal halide compound starting material may be selected from a wide variety of compounds known in the art. The invention herein most prefers metals selected from Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, Si, Ge, a Lanthanide series element or an Actinide series element. Illustrative metal halide compounds include, for example, Ru(PPh₃)₃Cl₂, Ru(PPh₃)₄Cl₂, [Ru(C₆H₆)Cl₂]₂, Ru(NCCH₃)₄Cl₂, [Ru(CO)₃Cl₂]₂, Fe(PPh₃)₃Cl₂, Os(PPh₃)₃Cl₂, and the like.

The concentration of the metal source compound starting material can vary over a wide range, and need only be that minimum amount necessary to react with the salt to produce organometallic compounds of this invention. In general, depending on the size of the reaction mixture, metal source compound starting material concentrations in the range of from about 1 millimole or less to about 10,000 millimoles or greater, should be sufficient for most processes.

The salt starting material may be selected from a wide variety of compounds known in the art. Illustrative salts include sodium cyclopentadienide, potassium cyclopentadienide, lithium cyclopentadienide, lithium 2,5-dimethylpyrrolide, trimethylsilyl methylboratabenzene, and the like. The salt starting material is preferably sodium cyclopentadienide and the like.

The concentration of the salt starting material can vary over a wide range, and need only be an excess stoichiometric amount, e.g., salt to metal halide of 2:1 or greater, necessary to react with the metal source compound starting material to produce the organometallic compound. In general, depending on the size of the reaction mixture, salt starting material concentrations in the range of from about 1 millimole or less to about 10,000 millimoles or greater, should be sufficient for most processes.

The solvent employed in the method of this invention may be any saturated and unsaturated hydrocarbons, aromatic hydrocarbons, aromatic heterocycles, alkyl halides, silylated hydrocarbons, ethers, polyethers, thioethers, esters, thioesters, lactones, amides, amines, polyamines, silicone oils, other aprotic solvents, or mixtures of one or more of the above; more preferably, diethylether, pentanes, or dimethoxyethanes; and most preferably toluene or dimethoxyethane (DME) or mixtures thereof. Any suitable solvent which does not unduly adversely interfere with the intended reaction can be employed. Mixtures of one or more different solvents may be employed if desired. The amount of solvent employed is not critical to the subject invention and need only be that amount sufficient to solubilize the reaction components in the reaction mixture. In general, the amount of solvent may range from about 5 percent by weight up to about 99 percent by weight or more based on the total weight of the reaction mixture starting materials.

Reaction conditions for the reaction of the salt compound with the metal source compound to produce the organometallic compound, such as temperature, pressure and contact time, may also vary greatly and any suitable combination of such conditions may be employed herein. The reaction temperature may be the reflux temperature of any of the aforementioned solvents, and more preferably between about −80° C. to about 150° C., and most preferably between about 20° C. to about 120° C. Normally the reaction is carried out under ambient pressure and the contact time may vary from a matter of seconds or minutes to a few hours or greater. The reactants can be added to the reaction mixture or combined in any order. The stir time employed can range from about 0.1 to about 400 hours, preferably from about 1 to 75 hours, and more preferably from about 4 to 16 hours, for all steps.

Isolation of the organometallic compound may be achieved by filtering to remove solids, reduced pressure to remove solvent, and distillation (or sublimation) to afford the final pure compound. Chromatography may also be employed as a final purification method.

This invention further relates to a process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises dissolving or suspending a substituted or unsubstituted organometallic compound intermediate having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same, in a solvent to form a solution or suspension, and adding a substituted or unsubstituted 6 electron donor anionic ligand source material to said solution or suspension under conditions sufficient to produce said organometallic compound. The organometallic compound yield resulting from the process of this invention can be 40% or greater, preferably 35% or greater, and more preferably 30% or greater.

The process is particularly well-suited for large scale production since it can be conducted using the same equipment, some of the same reagents and process parameters that can easily be adapted to manufacture a wide range of products. The process provides for the synthesis of organometallic precursor compounds using a process where all manipulations can be carried out in a single vessel, and which route to the organometallic precursor compounds does not require the isolation of an intermediate complex.

The organometallic compound intermediate starting material may be selected from a wide variety of compounds known in the art. Illustrative organometallic compound intermediate starting materials include (biscycloheptadienyl)ruthenium, (bisboratabenzene)ruthenium, (bisimidazolyl)ruthenium, (bispentadienyl)ruthenium, (bispyrrolyl)ruthenium, and the like.

The concentration of the organometallic compound intermediate starting material can vary over a wide range, and need only be that minimum amount necessary to react with the 6 electron donor anionic ligand source material to produce organometallic compounds of this invention. In general, depending on the size of the reaction mixture, metal source compound starting material concentrations in the range of from about 1 millimole or less to about 10,000 millimoles or greater, should be sufficient for most processes.

The 6 electron donor anionic ligand source starting material may be selected from a wide variety of compounds known in the art. Illustrative 6 electron donor anionic ligand source materials include cyclopentadienyl, alkyl substituted cyclopentadienyl ligands, pyrrolyl, alkyl substituted pyrrolyl ligands, dialkyl-2,4-pentadienyl, and the like. The 6 electron donor anionic ligand source material is preferably 2,4-pentadienyl, lithium pyrrolide, lithium 2,4-pentadienide, lithium cycloheptadienide, or lithium boratabenzene and the like.

The concentration of the 6 electron donor anionic ligand source material can vary over a wide range, and need only be an amount necessary to react with the organometallic compound intermediate starting material to produce the organometallic compound. In general, depending on the size of the reaction mixture, 6 electron donor anionic ligand source material concentrations in the range of from about 1 millimole or less to about 10,000 millimoles or greater, should be sufficient for most processes.

The solvent employed in the method of this invention may be any saturated and unsaturated hydrocarbons, aromatic hydrocarbons, aromatic heterocycles, alkyl halides, silylated hydrocarbons, ethers, polyethers, thioethers, esters, thioesters, lactones, amides, amines, polyamines, silicone oils, other aprotic solvents, or mixtures of one or more of the above; more preferably, diethylether, pentanes, or dimethoxyethanes; and most preferably toluene or dimethoxyethane (DME) or mixtures thereof. Any suitable solvent which does not unduly adversely interfere with the intended reaction can be employed. Mixtures of one or more different solvents may be employed if desired. The amount of solvent employed is not critical to the subject invention and need only be that amount sufficient to solubilize the reaction components in the reaction mixture. In general, the amount of solvent may range from about 5 percent by weight up to about 99 percent by weight or more based on the total weight of the reaction mixture starting materials.

Reaction conditions for the reaction of the organometallic compound intermediate starting material with the 6 electron donor anionic ligand source material to produce the organometallic compound, such as temperature, pressure and contact time, may also vary greatly and any suitable combination of such conditions may be employed herein. The reaction temperature may be the reflux temperature of any of the aforementioned solvents, and more preferably between about −80° C. to about 210° C., and most preferably between about 20° C. to about 120° C. Normally the reaction is carried out under ambient pressure and the contact time may vary from a matter of seconds or minutes to a few hours or greater. The reactants can be added to the reaction mixture or combined in any order. The stir time employed can range from about 0.1 to about 400 hours, preferably from about 1 to 75 hours, and more preferably from about 4 to 16 hours, for all steps.

Isolation of the organometallic compound may be achieved by filtering to remove solids, reduced pressure to remove solvent, and distillation (or sublimation) to afford the final pure compound. Chromatography may also be employed as a final purification method.

One example of the above process is shown below:

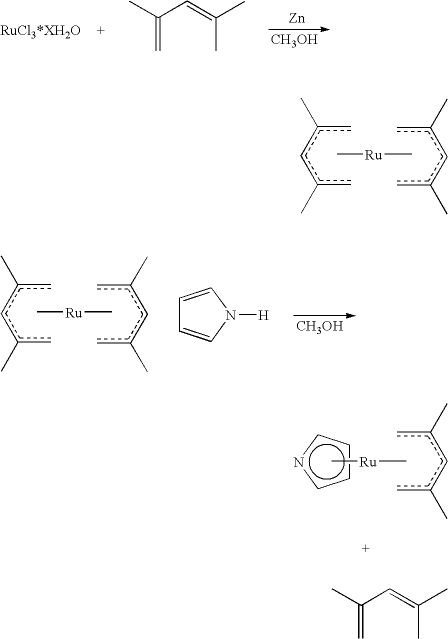

Other alternative processes that may be used in preparing the organometallic compounds of this invention include those disclosed in U.S. Pat. No. 6,605,735 B2 and U.S. Patent Application Publication No. US 2004/0127732 A1, published Jul. 1, 2004, the disclosure of which is incorporated herein by reference. The organometallic compounds of this invention may also be prepared by conventional processes such as described in Legzdins, P. et al. Inorg. Synth. 1990, 28, 196 and references therein.

For organometallic compounds prepared by the method of this invention, purification can occur through recrystallization, more preferably through extraction of reaction residue (e.g., hexane) and chromatography, and most preferably through sublimation and distillation.

Those skilled in the art will recognize that numerous changes may be made to the method described in detail herein, without departing in scope or spirit from the present invention as more particularly defined in the claims below.

Examples of techniques that can be employed to characterize the organometallic compounds formed by the synthetic methods described above include, but are not limited to, analytical gas chromatography, nuclear magnetic resonance, thermogravimetric analysis, inductively coupled plasma mass spectrometry, differential scanning calorimetry, vapor pressure and viscosity measurements.

Relative vapor pressures, or relative volatility, of organometallic precursor compounds described above can be measured by thermogravimetric analysis techniques known in the art. Equilibrium vapor pressures also can be measured, for example by evacuating all gases from a sealed vessel, after which vapors of the compounds are introduced to the vessel and the pressure is measured as known in the art.

The organometallic precursor compounds described herein are well suited for preparing in-situ powders and coatings. For instance, an organometallic precursor compound can be applied to a substrate and then heated to a temperature sufficient to decompose the precursor, thereby forming a metal coating on the substrate. Applying the precursor to the substrate can be by painting, spraying, dipping or by other techniques known in the art. Heating can be conducted in an oven, with a heat gun, by electrically heating the substrate, or by other means, as known in the art. A layered coating can be obtained by applying an organometallic precursor compound, and heating and decomposing it, thereby forming a first layer, followed by at least one other coating with the same or different precursors, and heating.

Organometallic precursor compounds such as described above also can be atomized and sprayed onto a substrate. Atomization and spraying means, such as nozzles, nebulizers and others, that can be employed are known in the art.

This invention provides in part an organometallic precursor and a method of forming a metal layer on a substrate by CVD or ALD of the organometallic precursor. In one aspect of the invention, an organometallic precursor of this invention is used to deposit a metal layer at subatmospheric pressures. The method for depositing the metal layer comprises introducing the precursor into a processing chamber, preferably maintained at a pressure of less than about 20 Torr, and dissociating the precursor in the presence of a processing gas to deposit a metal layer. The precursor may be dissociated and deposited by a thermal or plasma-enhanced process. The method may further comprise a step of exposing the deposited layer to a plasma process to remove contaminants, density the layer, and reduce the layer's resistivity.

In preferred embodiments of the invention, an organometallic compound, such as described above, is employed in gas phase deposition techniques for forming powders, films or coatings. The compound can be employed as a single source precursor or can be used together with one or more other precursors, for instance, with vapor generated by heating at least one other organometallic compound or metal complex. More than one organometallic precursor compound, such as described above, also can be employed in a given process.

As indicated above, this invention also relates in part to a method for producing a film, coating or powder. The method includes the step of decomposing at least one organometallic precursor compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; thereby producing the film, coating or powder, as further described below.

Deposition methods described herein can be conducted to form a film, powder or coating that includes a single metal or a film, powder or coating that includes a single metal. Mixed films, powders or coatings also can be deposited, for instance mixed metal films.

Gas phase film deposition can be conducted to form film layers of a desired thickness, for example, in the range of from about 1 nm to over 1 mm. The precursors described herein are particularly useful for producing thin films, e.g., films having a thickness in the range of from about 10 nm to about 100 nm. Films of this invention, for instance, can be considered for fabricating metal electrodes, in particular as n-channel metal electrodes in logic, as capacitor electrodes for DRAM applications, and as dielectric materials.

The method also is suited for preparing layered films, wherein at least two of the layers differ in phase or composition. Examples of layered film include metal-insulator-semiconductor, and metal-insulator-metal.

In an embodiment, the invention is directed to a method that includes the step of decomposing vapor of an organometallic precursor compound described above, thermally, chemically, photochemically or by plasma activation, thereby forming a film on a substrate. For instance, vapor generated by the compound is contacted with a substrate having a temperature sufficient to cause the organometallic compound to decompose and form a film on the substrate.

The organometallic precursor compounds can be employed in chemical vapor deposition or, more specifically, in metal organic chemical vapor deposition processes known in the art. For instance, the organometallic precursor compounds described above can be used in atmospheric, as well as in low pressure, chemical vapor deposition processes. The compounds can be employed in hot wall chemical vapor deposition, a method in which the entire reaction chamber is heated, as well as in cold or warm wall type chemical vapor deposition, a technique in which only the substrate is being heated.

The organometallic precursor compounds described above also can be used in plasma or photo-assisted chemical vapor deposition processes, in which the energy from a plasma or electromagnetic energy, respectively, is used to activate the chemical vapor deposition precursor. The compounds also can be employed in ion-beam, electron-beam assisted chemical vapor deposition processes in which, respectively, an ion beam or electron beam is directed to the substrate to supply energy for decomposing a chemical vapor deposition precursor. Laser-assisted chemical vapor deposition processes, in which laser light is directed to the substrate to affect photolytic reactions of the chemical vapor deposition precursor, also can be used.

The method of the invention can be conducted in various chemical vapor deposition reactors, such as, for instance, hot or cold-wall reactors, plasma-assisted, beam-assisted or laser-assisted reactors, as known in the art.

Examples of substrates that can be coated employing the method of the invention include solid substrates such as metal substrates, e.g., Al, Ni, Ti, Co, Pt, metal silicides, e.g., TiSi₂, CoSi₂, NiSi₂; semiconductor materials, e.g., Si, SiGe, GaAs, InP, diamond, GaN, SiC; insulators, e.g., SiO₂, Si₃N₄, HfO₂, Ta₂O₅, Al₂O₃, barium strontium titanate (BST); or on substrates that include combinations of materials. In addition, films or coatings can be formed on glass, ceramics, plastics, thermoset polymeric materials, and on other coatings or film layers. In preferred embodiments, film deposition is on a substrate used in the manufacture or processing of electronic components. In other embodiments, a substrate is employed to support a low resistivity conductor deposit that is stable in the presence of an oxidizer at high temperature or an optically transmitting film.

The method of this invention can be conducted to deposit a film on a substrate that has a smooth, flat surface. In an embodiment, the method is conducted to deposit a film on a substrate used in wafer manufacturing or processing. For instance, the method can be conducted to deposit a film on patterned substrates that include features such as trenches, holes or vias. Furthermore, the method of the invention also can be integrated with other steps in wafer manufacturing or processing, e.g., masking, etching and others.

In an embodiment of this invention, a plasma assisted ALD (PEALD) method has been developed for using the organometallic precursors to deposit metal films. The solid precursor can be sublimed under the flow of an inert gas to introduce it into a CVD chamber. Metal films are grown on a substrate with the aid of a hydrogen plasma.

Chemical vapor deposition films can be deposited to a desired thickness. For example, films formed can be less than 1 micron thick, preferably less than 500 nanometers and more preferably less than 200 nanometers thick. Films that are less than 50 nanometers thick, for instance, films that have a thickness between about 0.1 and about 20 nanometers, also can be produced.

Organometallic precursor compounds described above also can be employed in the method of the invention to form films by ALD processes or atomic layer nucleation (ALN) techniques, during which a substrate is exposed to alternate pulses of precursor, oxidizer and inert gas streams. Sequential layer deposition techniques are described, for example, in U.S. Pat. No. 6,287,965 and in U.S. Pat. No. 6,342,277. The disclosures of both patents are incorporated herein by reference in their entirety.

For example, in one ALD cycle, a substrate is exposed, in step-wise manner, to: a) an inert gas; b) inert gas carrying precursor vapor; c) inert gas; and d) oxidizer, alone or together with inert gas. In general, each step can be as short as the equipment will permit (e.g. milliseconds) and as long as the process requires (e.g. several seconds or minutes). The duration of one cycle can be as short as milliseconds and as long as minutes. The cycle is repeated over a period that can range from a few minutes to hours. Film produced can be a few nanometers thin or thicker, e.g., 1 millimeter (mm).

This invention includes a method for forming a metal-containing material on a substrate, e.g., a microelectronic device structure, from an organometallic precursor compound of this invention, said method comprising vaporizing said organometallic precursor compound to form a vapor, and contacting the vapor with the substrate to form said metal material thereon. After the metal is deposited on the substrate, the substrate may thereafter be metallized with copper or integrated with a ferroelectric thin film.

In an embodiment of this invention, a method is provided for fabricating a microelectronic device structure, said method comprising vaporizing an organometallic precursor compound to form a vapor, and contacting said vapor with a substrate to deposit a metal-containing film on the substrate, and thereafter incorporating the metal-containing film into a semiconductor integration scheme; wherein said organometallic precursor compound is represented by the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

The method of the invention also can be conducted using supercritical fluids. Examples of film deposition methods that use supercritical fluid that are currently known in the art include chemical fluid deposition; supercritical fluid transport-chemical deposition; supercritical fluid chemical deposition; and supercritical immersion deposition.

Chemical fluid deposition processes, for example, are well suited for producing high purity films and for covering complex surfaces and filling of high-aspect-ratio features. Chemical fluid deposition is described, for instance, in U.S. Pat. No. 5,789,027. The use of supercritical fluids to form films also is described in U.S. Pat. No. 6,541,278 B2. The disclosures of these two patents are incorporated herein by reference in their entirety.

In an embodiment of the invention, a heated patterned substrate is exposed to one or more organometallic precursor compounds, in the presence of a solvent, such as a near critical or supercritical fluid, e.g., near critical or supercritical CO₂. In the case of CO₂, the solvent fluid is provided at a pressure above about 1000 psig and a temperature of at least about 30° C.

The precursor is decomposed to form a metal film on the substrate. The reaction also generates organic material from the precursor. The organic material is solubilized by the solvent fluid and easily removed away from the substrate.

In an example, the deposition process is conducted in a reaction chamber that houses one or more substrates. The substrates are heated to the desired temperature by heating the entire chamber, for instance, by means of a furnace. Vapor of the organometallic compound can be produced, for example, by applying a vacuum to the chamber. For low boiling compounds, the chamber can be hot enough to cause vaporization of the compound. As the vapor contacts the heated substrate surface, it decomposes and forms a metal film. As described above, an organometallic precursor compound can be used alone or in combination with one or more components, such as, for example, other organometallic precursors, inert carrier gases or reactive gases.

In an embodiment of this invention, a method is provided for forming a metal-containing material on a substrate from an organometallic precursor compound, said method comprising vaporizing said organometallic precursor compound to form a vapor, and contacting the vapor with the substrate to form said metal material thereon; wherein said organometallic precursor compound has the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

In another embodiment of this invention, a method is provided for processing a substrate in a processing chamber, said method comprising (i) introducing an organometallic precursor compound into said processing chamber, (ii) heating said substrate to a temperature of about 100° C. to about 600° C., and (iii) reacting said organometallic precursor compound in the presence of a processing gas to deposit a metal-containing layer on said substrate; wherein said organometallic precursor compound has the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same or different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group.

In a system that can be used in producing films by the method of the invention, raw materials can be directed to a gas-blending manifold to produce process gas that is supplied to a deposition reactor, where film growth is conducted. Raw materials include, but are not limited to, carrier gases, reactive gases, purge gases, precursor, etch/clean gases, and others. Precise control of the process gas composition is accomplished using mass-flow controllers, valves, pressure transducers, and other means, as known in the art. An exhaust manifold can convey gas exiting the deposition reactor, as well as a bypass stream, to a vacuum pump. An abatement system, downstream of the vacuum pump, can be used to remove any hazardous materials from the exhaust gas. The deposition system can be equipped with in-situ analysis system, including a residual gas analyzer, which permits measurement of the process gas composition. A control and data acquisition system can monitor the various process parameters (e.g., temperature, pressure, flow rate, etc.).

The organometallic precursor compounds described above can be employed to produce films that include a single metal or a film that includes a single metal. Mixed films also can be deposited, for instance mixed metal films. Such films are produced, for example, by employing several organometallic precursors. Metal films also can be formed, for example, by using no carrier gas, vapor or other sources of oxygen.

Films formed by the methods described herein can be characterized by techniques known in the art, for instance, by X-ray diffraction, Auger spectroscopy, X-ray photoelectron emission spectroscopy, atomic force microscopy, scanning electron microscopy, and other techniques known in the art. Resistivity and thermal stability of the films also can be measured, by methods known in the art.

In addition to their use in semiconductor applications as chemical vapor or atomic layer deposition precursors for film depositions, the organometallic compounds of this invention may also be useful, for example, as catalysts, fuel additives and in organic syntheses.

Various modifications and variations of this invention will be obvious to a worker skilled in the art and it is to be understood that such modifications and variations are to be included within the purview of this application and the spirit and scope of the claims.

### EXAMPLE 1

### Synthesis of chloro(ethylcyclopentadienyl)bis(triphenylphosphine)ruthenium(II)

A 2 liter, three-necked, round bottomed flask was charged with a teflon stirring bar, ethanol (1.0 liter) and PPh₃ (263 grams, 1.0 mol). A 250 milliliter dropping funnel, a 150 milliliter bath-jacketed dropping funnel, and a condenser were attached to the three necks of the 2 liter flask. Both dropping funnels were equipped with teflon valves that permitted their isolation from the atmosphere of the round-bottomed flask. A rubber septum was connected to the top of the 150 milliliter bath-jacketed dropping funnel. The top of the condenser was fitted with a T junction adapter and connected to an inert atmosphere. A heating mantle was placed beneath the 2 liter, three-necked, round-bottomed flask and the solution was stirred and heated to reflux. At reflux, all of the triphenylphosphine dissolved in the ethanol. The system was purged with nitrogen for 3 hours while at reflux.

While this was taking place, a 500 milliliter erlenmyer flask was charged with RuCl₃.XH₂O (50 grams, 0.20 mol), ethanol (150 milliliters) and a teflon coated magnetic stirring bar. The ethanolic solution immediately developed a brown/orange colour. To dissolve all of the RuCl₃.XH₂O, it was necessary to gently heat the solution. This solution was poured into the 250 milliliter dropping funnel and the dropping funnel was fitted with a rubber septum. This solution was sparged with nitrogen for 30 minutes by inserting a needle connected to a 1-2 psig nitrogen source through the septum and into the solution and by piercing the septum with another needle to allow for relief of excess pressure.

A methanol/dry ice bath was made up in the 150 milliliter bath-jacketed dropping funnel. The interior of this dropping funnel was purged with nitrogen for 30 minutes in a similar fashion to which the other dropping funnel was sparged. Ethylcyclopentadiene (116 grams, 1.2 mol, freshly distilled under a nitrogen atmosphere) was then cannulated into the cooled dropping funnel through the rubber septum.

After the 3 hours of purging, the 2 liter, round bottomed flask had elapsed, the teflon valves isolating the dropping funnels from the rest of the system were both opened and dropwise addition of the two solutions commenced simultaneously. Over the course of 20 minutes, the two solutions were both added to the ethanolic PPh₃ solution. During this entire time, the solution was at reflux. The solution quickly developed a deep orange brown color.

After the addition had been completed, the solution was left to reflux for an additional 2 hours. During this time, small red crystals could be seen accumulating above the meniscus of the solution on the walls of the 2 liter flask.

The solution was allowed to cool to slightly below reflux and the contents of the 2 liter flask were filtered (open to air) over a coarse frit. The red/orange solid was collected (198 grams). The filtrate was discarded and the solid was placed in a vacuum oven at 60° C. overnight. The solid was removed from the vacuum oven and tared on an analytical balance (150.2 grams). Based on this, the yield of crude chloro(ethylcyclopentadienyl)bis(triphenylphosphine)ruthenium(II) was determined to be greater than 99%.

### EXAMPLE 2

### Synthesis of (MeCp)(cycloheptadienyl)ruthenium

Chloro(methylcyclopentadienyl)bis(triphenylphosphine)ruthenium(II) was prepared in the same fashion as the ethyl derivative in Example 1 above.

A 3-necked, 250 milliliter, round bottomed flask is charged with chloro(methylcyclopentadienyl)bis(triphenylphosphine)ruthenium(II) (14.4 grams, 0.019 moles), a Teflon Stir bar and fitted with a reflux condenser, a glass stopper and a rubber septum. The contents of the flask are then connected to an argon/vacuum manifold and evacuated and backfilled with argon three times. Tetrahydrofuran (THF) (anhydrous, 150 milliliters) is then cannulated into the flask and stirring is initiated.

To this solution another solution, prepared in advance of, lithium cycloheptadienide (1.0 M in THF, 20 milliliters, 0.020 moles) is then cannulated into the reaction vessel over 5 minutes. Following the addition of this solution, the entire contents of the 250 milliliter flask are heated and stirred. The solution is refluxed for 4 hours.

After a 4 hour reflux, the contents of the 250 milliliter flask are cooled to room temperature and solvent is removed under reduced pressure. The remaining contents are then heated under vacuum and the product (methylcylopentadienyl)(cycloheptadienyl)ruthenium is isolated by fractional distillation.

### EXAMPLE 3

### Synthesis of (EtCp)(methylboratabenzene)ruthenium

Chloro(ethylcyclopentadienyl)bis(triphenylphosphine)ruthenium(II) was prepared in the same fashion as described above in Example 1.

A 3-necked, 250 milliliter, roundbottomed flask is charged with chloro(ethylcyclopentadienyl)bis(triphenylphosphine)ruthenium(II) (15.2 grams, 0.020 moles), a Teflon Stir bar and fitted with a reflux condenser, a glass stopper and a rubber septum. The contents of the flask are then connected to an argon/vacuum manifold and evacuated and backfilled with argon three times. Tetrahydrofuran (THF) (anhydrous, 150 milliliters) is then cannulated into the flask and stirring is initiated.

To this solution another solution, prepared in advance of, lithium methylboratabenzene (1.0 M in THF, 20 milliliters, 0.020 moles) is then cannulated into the reaction vessel over 5 minutes. Following the addition of this solution, the entire contents of the 250 milliliter flask are heated and stirred. The solution is refluxed for 4 hours.

After a 4 hour reflux, the contents of the 250 milliliter flask are cooled to room temperature and solvent is removed under reduced pressure. The remaining contents are then heated under vacuum and the product (ethylcylopentadienyl)(methylboratabenzene)ruthenium is isolated by fractional distillation.

1. A process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises reacting a metal halide and a first salt in the presence of a first solvent and under reaction conditions sufficient to produce an intermediate reaction material, and reacting said intermediate reaction material with a second salt in the presence of a second solvent and under reaction conditions sufficient to produce said organometallic compound.

2. The process of claim 1 wherein said metal halide comprises Ru(PPh₃)₃Cl₂, Ru(PPh₃)₄Cl₂, [Ru(C₆H₆)Cl₂]₂, Ru(NCCH₃)₄Cl₂, [Ru(CO)₃Cl₂]₂, Fe(PPh₃)₃Cl₂, or Os(PPh₃)₃Cl₂; said first salt comprises sodium cyclopentadienide, potassium cyclopentadienide, lithium cyclopentadienide, lithium 2,5-dimethylpyrrolide, or trimethylsilyl methylboratabenzene; said first solvent comprises tetrahydrofuran (THF), dimethoxyethane (DME), toluene or mixtures thereof, said intermediate reaction material is selected from (EtCp)Ru(PPh3)₂Cl, (C₄H₄N)Ru(PPh₃)₂Cl, and [(C₄H₄N)Ru(NCCH₃)₃]Cl; said second salt comprises lithium 2,5-dimethylpyrrolylide, lithium methylboratabenzene, or sodium imidazolide; and said second solvent comprises toluene, hexane or mixtures thereof.

3. The process of claim 1 wherein, for said organometallic compound:
(a) L₁ is selected from a substituted or unsubstituted cyclopentadienyl group or a substituted or unsubstituted cyclopentadienyl-like group, and L₂ is selected from a substituted or unsubstituted cycloheptadienyl group, a substituted or unsubstituted cycloheptadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted cyclopentadienyl-like group is selected from cyclohexadienyl, cycloheptadienyl, cyclooctadienyl, heterocyclic group and aromatic group, the substituted or unsubstituted cycloheptadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(b) L₁ is selected from a substituted or unsubstituted cycloheptadienyl group or a substituted or unsubstituted cycloheptadienyl-like group, and L₂ is selected from a substituted or unsubstituted pentadienyl group, a substituted or unsubstituted pentadienyl-like group, a substituted or unsubstituted cyclopentadienyl group, a substituted or unsubstituted cyclopentadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(c) L₁ is selected from a substituted or unsubstituted pentadienyl group or a substituted or unsubstituted pentadienyl-like group, and L₂ is selected from a substituted or unsubstituted cycloheptadienyl group, a substituted or unsubstituted cycloheptadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted pentadienyl-like group is selected from linear olefins, hexadienyl, heptadienyl and octadienyl, the substituted or unsubstituted cycloheptadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(d) L₁ is selected from a substituted or unsubstituted pyrrolyl group or a substituted or unsubstituted pyrrolyl-like group, and L₂ is selected from a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted pyrrolyl-like group is selected from pyrrolinyl, pyrazolyl, thiazolyl, oxazolyl, carbazolyl, triazolyl, indolyl and purinyl, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(e) L₁ is selected from a substituted or unsubstituted boratabenzene group or a substituted or unsubstituted boratabenzene-like group, and L₂ is selected from a substituted or unsubstituted pentadienyl group, a substituted or unsubstituted pentadienyl-like group, a substituted or unsubstituted cycloheptadienyl group, a substituted or unsubstituted cycloheptadienyl-like group, a substituted or unsubstituted cyclopentadienyl group, a substituted or unsubstituted cyclopentadienyl-like group, a substituted or unsubstituted pyrrolyl group, a substituted or unsubstituted pyrrolyl-like group, a substituted or unsubstituted imidazolyl group or a substituted or unsubstituted imidazolyl-like group; wherein the substituted or unsubstituted boratabenzene-like group is selected from methylboratabenzene, ethylboratabenzene and 1-methyl-3-ethylboratabenzene, the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted pyrrolyl-like group is selected from pyrrolinyl, pyrazolyl, thiazolyl, oxazolyl, carbazolyl, triazolyl, indolyl and purinyl, and the substituted or unsubstituted imidazolyl-like group is selected from pyrrolinyl, pyrazolyl, thiazolyl, oxazolyl, carbazolyl, triazolyl, indolyl and purinyl; or
(f) L₁ is selected from a substituted or unsubstituted imidazolyl group or a substituted or unsubstituted imidazolyl-like group, and L₂ is selected from a substituted or unsubstituted pentadienyl group, a substituted or unsubstituted pentadienyl-like group, a substituted or unsubstituted cycloheptadienyl group, a substituted or unsubstituted cycloheptadienyl-like group, a substituted or unsubstituted cyclopentadienyl group, a substituted or unsubstituted cyclopentadienyl-like group, a substituted or unsubstituted pyrrolyl group, a substituted or unsubstituted pyrrolyl-like group, a substituted or unsubstituted boratabenzene group, a substituted or unsubstituted boratabenzene-like group, a substituted or unsubstituted imidazolyl group which can be the same or different as L₁ or a substituted or unsubstituted imidazolyl-like group which can be the same or different as L₁; wherein the substituted or unsubstituted imidazolyl-like groups are selected from pyrrolinyl, pyrazolyl, thiazolyl, oxazolyl, carbazolyl, triazolyl, indolyl and purinyl, the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted pyrrolyl-like group is selected from pyrrolinyl, pyrazolyl, thiazolyl, oxazolyl, carbazolyl, triazolyl, indolyl and purinyl, and the substituted or unsubstituted boratabenzene-like group is selected from methylboratabenzene, ethylboratabenzene and 1-methyl-3-ethylboratabenzene.

4. The process of claim 1 wherein, for said organometallic compound, M is selected from Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, Si, Ge, a Lanthanide series element or an Actinide series element.

5. The process of claim 1 wherein said organometallic compound is selected from (cyclopentadienyl)(cycloheptadienyl)ruthenium, (cyclopentadienyl)(methylboratabenzene)ruthenium, (cyclopentadienyl)(imidazolyl)ruthenium, (pentadienyl)(cycloheptadienyl)ruthenium, (pentadienyl)(boratabenzene)ruthenium, (pentadienyl)(imidazolyl)ruthenium, (cycloheptadienyl)(methylboratabenzene)ruthenium, (cycloheptadienyl)(imidazolyl)ruthenium, (pyrrolyl)(methylboratabenzene)ruthenium, (pyrrolyl)(imidazolyl)ruthenium, (methylboratabenzene)(imidazolyl)ruthenium, bis(imidazolyl)ruthenium, (ethylcyclopentadienyl)(cycloheptadienyl)ruthenium, (methylboratabenzene)(cycloheptadienyl)ruthenium, bis(ethylboratabenzene)ruthenium, (methylcyclopentadienyl)(cycloheptadienyl)ruthenium, (methylcyclopentadienyl)(methylboratabenzene)ruthenium, (ethylcyclopentadienyl)(methylboratabenzene)ruthenium, (methylcyclopentadienyl)(methylboratabenzene)ruthenium, (methylcyclopentadienyl)(imidazolyl)ruthenium, (ethylcyclopentadienyl)(imidazolyl)ruthenium, (isopropylcyclopentadienyl)(cycloheptadienyl)ruthenium, (tert-butylcyclopentadienyl)(cycloheptadienyl)ruthenium, (isopropylcyclopentadienyl)(methylboratabenzene)ruthenium, (tert-butylcyclopentadienyl)(methylboratabenzene)ruthenium, (isopropylcyclopentadienyl)(imidazolyl)ruthenium, (tert-butylcyclopentadienyl)(imidazolyl)ruthenium, (2,4-dimethylpentadienyl)(cycloheptadienyl)ruthenium, (pentadienyl)(methylboratabenzene)ruthenium, (cyclohexadienyl)(cycloheptadienyl)ruthenium, (cyclopentadienyl)(cyclohexadienyl)ruthenium, (cyclohexadienyl)(methylboratabenzene)ruthenium, and (cyclohexadienyl)(imidazolyl)ruthenium.

6. A process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises reacting a metal halide with an excess stoichiometric amount of a salt in the presence of a solvent and under reaction conditions sufficient to produce said organometallic compound.

7. The process of claim 6 wherein said excess stoichiometric amount of said salt to said metal halide is 2:1 or greater.

8. The process of claim 6 wherein said metal halide comprises Ru(PPh₃)₃Cl₂, Ru(PPh₃)₄Cl₂, [Ru(C₆H₆)Cl₂]₂, Ru(NCCH₃)₄Cl₂, [Ru(CO)₃Cl₂]₂, Fe(PPh₃)₃Cl₂, or Os(PPh₃)₃Cl₂; said salt comprises sodium cyclopentadienide, potassium cyclopentadienide, lithium cyclopentadienide, lithium 2,5-dimethylpyrrolide, or trimethylsilyl methylboratabenzene; and said solvent comprises tetrahydrofuran (THF), dimethoxyethane (DME), toluene or mixtures thereof.

9. The process of claim 6 wherein, for said organometallic compound:
(a) L₁ is selected from a substituted or unsubstituted cyclopentadienyl group or a substituted or unsubstituted cyclopentadienyl-like group, and L₂ is selected from a substituted or unsubstituted cycloheptadienyl group, a substituted or unsubstituted cycloheptadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted cyclopentadienyl-like group is selected from cyclohexadienyl, cycloheptadienyl, cyclooctadienyl, heterocyclic group and aromatic group, the substituted or unsubstituted cycloheptadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(b) L₁ is selected from a substituted or unsubstituted cycloheptadienyl group or a substituted or unsubstituted cycloheptadienyl-like group, and L₂ is selected from a substituted or unsubstituted pentadienyl group, a substituted or unsubstituted pentadienyl-like group, a substituted or unsubstituted cyclopentadienyl group, a substituted or unsubstituted cyclopentadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(c) L₁ is selected from a substituted or unsubstituted pentadienyl group or a substituted or unsubstituted pentadienyl-like group, and L₂ is selected from a substituted or unsubstituted cycloheptadienyl group, a substituted or unsubstituted cycloheptadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted pentadienyl-like group is selected from linear olefins, hexadienyl, heptadienyl and octadienyl, the substituted or unsubstituted cycloheptadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(d) L₁ is selected from a substituted or unsubstituted pyrrolyl group or a substituted or unsubstituted pyrrolyl-like group, and L₂ is selected from a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted pyrrolyl-like group is selected from pyrrolinyl, pyrazolyl, thiazolyl, oxazolyl, carbazolyl, triazolyl, indolyl and purinyl, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(e) L₁ is selected from a substituted or unsubstituted boratabenzene group or a substituted or unsubstituted boratabenzene-like group, and L₂ is selected from a substituted or unsubstituted pentadienyl group, a substituted or unsubstituted pentadienyl-like group, a substituted or unsubstituted cycloheptadienyl group, a substituted or unsubstituted cycloheptadienyl-like group, a substituted or unsubstituted cyclopentadienyl group, a substituted or unsubstituted cyclopentadienyl-like group, a substituted or unsubstituted pyrrolyl group, a substituted or unsubstituted pyrrolyl-like group, a substituted or unsubstituted imidazolyl group or a substituted or unsubstituted imidazolyl-like group; wherein the substituted or unsubstituted boratabenzene-like group is selected from methylboratabenzene, ethylboratabenzene and 1-methyl-3-ethylboratabenzene, the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted pyrrolyl-like group is selected from pyrrolinyl, pyrazolyl, thiazolyl, oxazolyl, carbazolyl, triazolyl, indolyl and purinyl, and the substituted or unsubstituted imidazolyl-like group is selected from pyrrolinyl, pyrazolyl, thiazolyl, oxazolyl, carbazolyl, triazolyl, indolyl and purinyl; or
(f) L₁ is selected from a substituted or unsubstituted imidazolyl group or a substituted or unsubstituted imidazolyl-like group, and L₂ is selected from a substituted or unsubstituted pentadienyl group, a substituted or unsubstituted pentadienyl-like group, a substituted or unsubstituted cycloheptadienyl group, a substituted or unsubstituted cycloheptadienyl-like group, a substituted or unsubstituted cyclopentadienyl group, a substituted or unsubstituted cyclopentadienyl-like group, a substituted or unsubstituted pyrrolyl group, a substituted or unsubstituted pyrrolyl-like group, a substituted or unsubstituted boratabenzene group, a substituted or unsubstituted boratabenzene-like group, a substituted or unsubstituted imidazolyl group which can be the same or different as L₁ or a substituted or unsubstituted imidazolyl-like group which can be the same or different as L₁; wherein the substituted or unsubstituted imidazolyl-like groups are selected from pyrrolinyl, pyrazolyl, thiazolyl, oxazolyl, carbazolyl, triazolyl, indolyl and purinyl, the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted pyrrolyl-like group is selected from pyrrolinyl, pyrazolyl, thiazolyl, oxazolyl, carbazolyl, triazolyl, indolyl and purinyl, and the substituted or unsubstituted boratabenzene-like group is selected from methylboratabenzene, ethylboratabenzene and 1-methyl-3-ethylboratabenzene.

10. The process of claim 6 wherein, for said organometallic compound, M is selected from Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, Si, Ge, a Lanthanide series element or an Actinide series element.

11. The process of claim 6 wherein said organometallic compound is selected from (cyclopentadienyl)(cycloheptadienyl)ruthenium, (cyclopentadienyl)(methylboratabenzene)ruthenium, (cyclopentadienyl)(imidazolyl)ruthenium, (pentadienyl)(cycloheptadienyl)ruthenium, (pentadienyl)(boratabenzene)ruthenium, (pentadienyl)(imidazolyl)ruthenium, (cycloheptadienyl)(methylboratabenzene)ruthenium, (cycloheptadienyl)(imidazolyl)ruthenium, (pyrrolyl)(methylboratabenzene)ruthenium, (pyrrolyl)(imidazolyl)ruthenium, (methylboratabenzene)(imidazolyl)ruthenium, bis(imidazolyl)ruthenium, (ethylcyclopentadienyl)(cycloheptadienyl)ruthenium, (methylboratabenzene)(cycloheptadienyl)ruthenium, bis(ethylboratabenzene)ruthenium, (methylcyclopentadienyl)(cycloheptadienyl)ruthenium, (methylcyclopentadienyl)(methylboratabenzene)ruthenium, (ethylcyclopentadienyl)(methylboratabenzene)ruthenium, (methylcyclopentadienyl)(methylboratabenzene)ruthenium, (methylcyclopentadienyl)(imidazolyl)ruthenium, (ethylcyclopentadienyl)(imidazolyl)ruthenium, (isopropylcyclopentadienyl)(cycloheptadienyl)ruthenium, (tert-butylcyclopentadienyl)(cycloheptadienyl)ruthenium, (isopropylcyclopentadienyl)(methylboratabenzene)ruthenium, (tert-butylcyclopentadienyl)(methylboratabenzene)ruthenium, (isopropylcyclopentadienyl)(imidazolyl)ruthenium, (tert-butylcyclopentadienyl)(imidazolyl)ruthenium, (2,4-dimethylpentadienyl)(cycloheptadienyl)ruthenium, (pentadienyl)(methylboratabenzene)ruthenium, (cyclohexadienyl)(cycloheptadienyl)ruthenium, (cyclopentadienyl)(cyclohexadienyl)ruthenium, (cyclohexadienyl)(methylboratabenzene)ruthenium, and (cyclohexadienyl)(imidazolyl)ruthenium.

12. A process for producing an organometallic compound having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are different; with the proviso that (i) when L₁ is a substituted or unsubstituted pyrrolyl group or a substituted or unsubstituted pyrrolyl-like group, then L₂ is other than a substituted or unsubstituted cyclopentadienyl group, a substituted or unsubstituted cyclopentadienyl-like group, a substituted or unsubstituted pentadienyl group, a substituted or unsubstituted pentadienyl-like group, a substituted or unsubstituted pyrrolyl group or a substituted or unsubstituted pyrrolyl-like group, (ii) when L₁ is a substituted or unsubstituted cyclopentadienyl group or a substituted or unsubstituted cyclopentadienyl-like group, then L₂ is other than a substituted or unsubstituted pentadienyl group, a substituted or unsubstituted pentadienyl-like group, a substituted or unsubstituted cyclopentadienyl group, or a substituted or unsubstituted cyclopentadienyl-like group, and (iii) when L₁ is a substituted or unsubstituted pentadienyl group, then L₂ is other than a substituted or unsubstituted pentadienyl group; which process comprises dissolving or suspending a substituted or unsubstituted organometallic compound intermediate having the formula L₁ML₂ wherein M is a metal or metalloid, L₁ is a substituted or unsubstituted 6 electron donor anionic ligand, and L₂ is a substituted or unsubstituted 6 electron donor anionic ligand, wherein L₁ and L₂ are the same, in a solvent to form a solution or suspension, and adding a substituted or unsubstituted 6 electron donor anionic ligand source material to said solution or suspension under conditions sufficient to produce said organometallic compound.

13. The process of claim 12 wherein said organometallic compound intermediate comprises (biscycloheptadienyl)ruthenium, (bisboratabenzene)ruthenium, (bisimidazolyl)ruthenium, (bispentadienyl)ruthenium, or (bispyrrolyl)ruthenium; said substituted or unsubstituted 6 electron donor anionic ligand source material comprises lithium pyrrolide, lithium 2,4-pentadienide, lithium cycloheptadienide, or lithium boratabenzene; and said solvent comprises methanol, tetrahydrofuran (THF), dimethoxyethane (DME), toluene, hexane or mixtures thereof.

14. The process of claim 12 wherein, for said organometallic compound:
(a) L₁ is selected from a substituted or unsubstituted cyclopentadienyl group or a substituted or unsubstituted cyclopentadienyl-like group, and L₂ is selected from a substituted or unsubstituted cycloheptadienyl group, a substituted or unsubstituted cycloheptadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted cyclopentadienyl-like group is selected from cyclohexadienyl, cycloheptadienyl, cyclooctadienyl, heterocyclic group and aromatic group, the substituted or unsubstituted cycloheptadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(b) L₁ is selected from a substituted or unsubstituted cycloheptadienyl group or a substituted or unsubstituted cycloheptadienyl-like group, and L₂ is selected from a substituted or unsubstituted pentadienyl group, a substituted or unsubstituted pentadienyl-like group, a substituted or unsubstituted cyclopentadienyl group, a substituted or unsubstituted cyclopentadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(c) L₁ is selected from a substituted or unsubstituted pentadienyl group or a substituted or unsubstituted pentadienyl-like group, and L₂ is selected from a substituted or unsubstituted cycloheptadienyl group, a substituted or unsubstituted cycloheptadienyl-like group, a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted pentadienyl-like group is selected from linear olefins, hexadienyl, heptadienyl and octadienyl, the substituted or unsubstituted cycloheptadienyl-like group is selected from cyclohexadienyl, cyclooctadienyl, heterocyclic group and aromatic group, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(d) L₁ is selected from a substituted or unsubstituted pyrrolyl group or a substituted or unsubstituted pyrrolyl-like group, and L₂ is selected from a substituted or unsubstituted boratabenzene group, a substituted or unsubstituted boratabenzene-like group, a substituted or unsubstituted imidazolyl group or a substituted or unsubstituted imidazolyl-like group; wherein the substituted or unsubstituted pyrrolyl-like group is selected from pyrrolinyl, pyrazolyl, thiazolyl, oxazolyl, carbazolyl, triazolyl, indolyl and purinyl, the substituted or unsubstituted boratabenzene-like group is selected from methylboratabenzene, ethylboratabenzene and 1-methyl-3-ethylboratabenzene, and the substituted or unsubstituted imidazolyl-like group is selected from pyrrolinyl, pyrazolyl, thiazolyl, oxazolyl, carbazolyl, triazolyl, indolyl and purinyl;
(e) L₁ is selected from a substituted or unsubstituted boratabenzene group or a substituted or unsubstituted boratabenzene-like group, and L₂ is selected from a substituted or unsubstituted pentadienyl group, a substituted or unsubstituted pentadienyl-like group, a substituted or unsubstituted cycloheptadienyl group, a substituted or unsubstituted cycloheptadienyl-like group, a substituted or unsubstituted cyclopentadienyl group, a substituted or unsubstituted cyclopentadienyl-like group, a substituted or unsubstituted pyrrolyl group, a substituted or unsubstituted pyrrolyl-like group, a substituted or unsubstituted imidazolyl group or a substituted or unsubstituted imidazolyl-like group; wherein the substituted or unsubstituted boratabenzene-like group is selected from methylboratabenzene, ethylboratabenzene and 1-methyl-3-ethylboratabenzene, the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted pyrrolyl-like group is selected from pyrrolinyl, pyrazolyl, thiazolyl, oxazolyl, carbazolyl, triazolyl, indolyl and purinyl, and the substituted or unsubstituted imidazolyl-like group is selected from pyrrolinyl, pyrazolyl, thiazolyl, oxazolyl, carbazolyl, triazolyl, indolyl and purinyl; or
(f) L₁ is selected from a substituted or unsubstituted imidazolyl group or a substituted or unsubstituted imidazolyl-like group, and L₂ is selected from a substituted or unsubstituted pentadienyl group, a substituted or unsubstituted pentadienyl-like group, a substituted or unsubstituted cycloheptadienyl group, a substituted or unsubstituted cycloheptadienyl-like group, a substituted or unsubstituted cyclopentadienyl group, a substituted or unsubstituted cyclopentadienyl-like group, a substituted or unsubstituted pyrrolyl group, a substituted or unsubstituted pyrrolyl-like group, a substituted or unsubstituted boratabenzene group, a substituted or unsubstituted boratabenzene-like group, a substituted or unsubstituted imidazolyl group which can be the same or different as L₁ or a substituted or unsubstituted imidazolyl-like group which can be the same or different as L₁; wherein the substituted or unsubstituted imidazolyl-like groups are selected from pyrrolinyl, pyrazolyl, thiazolyl, oxazolyl, carbazolyl, triazolyl, indolyl and purinyl, the substituted or unsubstituted cycloheptadienyl-like group is selected from cyclohexadienyl, cyclooctadienyl, heterocyclic group and aromatic group, the substituted or unsubstituted pentadienyl-like group is selected from linear olefins, hexadienyl, heptadienyl and octadienyl, the substituted or unsubstituted cyclopentadienyl-like group is selected from cyclohexadienyl, cyclooctadienyl, heterocyclic group and aromatic group, the substituted or unsubstituted pyrrolyl-like group is selected from pyrrolinyl, pyrazolyl, thiazolyl, oxazolyl, carbazolyl, triazolyl, indolyl and purinyl, and the substituted or unsubstituted boratabenzene-like group is selected from methylboratabenzene, ethylboratabenzene and 1-methyl-3-ethylboratabenzene.

15. The process of claim 12 wherein, for said organometallic compound, M is selected from Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, Si, Ge, a Lanthanide series element or an Actinide series element.

16. The process of claim 12 wherein said organometallic compound is selected from (cyclopentadienyl)(cycloheptadienyl)ruthenium, (cyclopentadienyl)(methylboratabenzene)ruthenium, (cyclopentadienyl)(imidazolyl)ruthenium, (pentadienyl)(cycloheptadienyl)ruthenium, (pentadienyl)(boratabenzene)ruthenium, (pentadienyl)(imidazolyl)ruthenium, (cycloheptadienyl)(methylboratabenzene)ruthenium, (cycloheptadienyl)(imidazolyl)ruthenium, (pyrrolyl)(methylboratabenzene)ruthenium, (pyrrolyl)(imidazolyl)ruthenium, (methylboratabenzene)(imidazolyl)ruthenium, bis(imidazolyl)ruthenium, (ethylcyclopentadienyl)(cycloheptadienyl)ruthenium, (methylboratabenzene)(cycloheptadienyl)ruthenium, bis(ethylboratabenzene)ruthenium, (methylcyclopentadienyl)(cycloheptadienyl)ruthenium, (methylcyclopentadienyl)(methylboratabenzene)ruthenium, (ethylcyclopentadienyl)(methylboratabenzene)ruthenium, (methylcyclopentadienyl)(methylboratabenzene)ruthenium, (methylcyclopentadienyl)(imidazolyl)ruthenium, (ethylcyclopentadienyl)(imidazolyl)ruthenium, (isopropylcyclopentadienyl)(cycloheptadienyl)ruthenium, (tert-butylcyclopentadienyl)(cycloheptadienyl)ruthenium, (isopropylcyclopentadienyl)(methylboratabenzene)ruthenium, (tert-butylcyclopentadienyl)(methylboratabenzene)ruthenium, (isopropylcyclopentadienyl)(imidazolyl)ruthenium, (tert-butylcyclopentadienyl)(imidazolyl)ruthenium, (2,4-dimethylpentadienyl)(cycloheptadienyl)ruthenium, (pentadienyl)(methylboratabenzene)ruthenium, (cyclohexadienyl)(cycloheptadienyl)ruthenium, (cyclopentadienyl)(cyclohexadienyl)ruthenium, (cyclohexadienyl)(methylboratabenzene)ruthenium, and (cyclohexadienyl)(imidazolyl)ruthenium.
